(19) United States
(12) Patent Application Publication
(10) Pub. No.: US 2026/0255450 A1
(43) Pub. Date: Aug. 27, 2026

(54) INDUCTION HOB AND OPERATION METHOD THEREOF

(71) Applicant: ELECTROLUX APPLIANCES AKTIEBOLAG, Stockholm (SE)

(72) Inventors: Alex VIROLI, Forli (IT); Massimo NOSTRO, Forli (IT); Filippo MARTINI, Forli (IT); Fabio ANGELI, Forli (IT)

(21) Appl. No.: 19/163,023

(22) PCT Filed: Feb. 21, 2024
(86) PCT No.: PCT/EP2024/054375

§ 371 Date: Sep. 8, 2025

(30) Foreign Application Priority Data
Mar. 9, 2023 (EP) 23161086.6

(51) Int. Cl. H05B 6/06

(52) U.S. Cl. CPC H05B 6/062

(57) ABSTRACT

Method of operation of an induction hob comprising at least an induction coil for heating a cookware, the method comprising the steps of: receiving a high power user-command indicatives of a high power level to be provided to said cookware during the cooking, controlling the induction coil in order to regulate the increase of heating power provided to the cookware from a low heating power level to said high power level, the method comprises the step of receiving a silent mode command which is indicative of a request of reducing the acoustic noise generated by the cookware when heated by the induction hob, measuring the temperature of the induction coil, measuring a time elapsed from receiving the high power user-command, delaying the increase of the heating power from the low heating power level to the high heating power level until a first condition or a second conditions are satisfied.

### TECHNICAL FIELD

The present invention generally concerns to the technical field of induction hobs. More specifically, the present invention concerns the reduction of acoustic noise generated by a cookware when it is heated by an induction hob.

### PRIOR ART

Induction hobs for preparing food are well known in prior art. Induction hobs typically comprise heating zones which are associated with induction coils. For heating a piece of cookware placed on a heating zone, the induction coils is electrically coupled with electronic driving units for driving an alternating current through the induction coil. The alternating current generates a time varying magnetic field. Due to the inductive coupling between the induction coils and the piece of cookware placed above the induction coil, the magnetic field generated by the induction coil causes eddy currents circulating in the piece of cookware. The presence of eddy currents generates heat within the piece of cookware due to the electrical resistance of the piece of cookware.

It is also known, that pots and cookwares usually generate acoustic noise when heated by induction hobs. Acoustic noise generated by cookware is highly dependent on their structure and construction and tends to be higher with lightweight cookware or multi-ply material e.g., stainless steel with aluminum core.

At the beginning of cooking cycle there is a difference of temperature between the outer and the inner layers of the cookware. Indeed the outer layer is heated immediately by the induction hob, whereas the inner layers are heated by thermal conduction. It follows that intensity of the noise generated by the cookware essentially depends on the heating power provided to the latter.

When heated by a high heating power the cookware generates an acoustic resonant frequency in the frequency range of human hearing which is disturbing for the users of hobs. In order to solve said technical problem of acoustic noise disturb, many solutions have been proposed.

Some known solutions are disclosed, for example, in CN000114263943A, JP002003257610A, JP002007323886A, JP002009301915A, US020030164373A1 and CN000109140543A.

In detail, solutions disclosed in CN000109140543A concern a noise reduction method which essentially comprises the steps of determining whether the cookware temperature is greater than a first predetermined temperature; when the temperature of the cookware is less than the first preset temperature, controlling the induction hob to heat the cookware with a first heating power; when the temperature of the cookware is greater than the first preset temperature, the induction hob is controlled to heat the cookware with a second heating power greater than the first heating power.

The solution disclosed in CN000109140543A needs the presence of a temperature sensor system, which according to different embodiments may be arranged in the handle of the cookware provided with a communication system to transmit the measured temperature to the control panel of the hob, or alternately in the induction hob in order to measure the temperature of the bottom of the cookware. Temperature sensor system disclosed in CN000109140543A is complex and expensive. Moreover, the embodiment with temperature sensor mounted in the cookware is unsuitable to be used for sensor-less cookware.

### DESCRIPTION OF THE INVENTION

The aim object of the present invention is therefore to provide a different method for reducing the acoustic noise generated by a cookware when heated by an induction hob, which is simpler and e cheaper to make than solutions disclosed above.

In accordance with this object, according to the present invention, it is provided a method of operation of an induction hob comprising at least an induction coil for heating a cookware, the method comprising the steps of: receiving a high power user-command which is indicative of a high power level to be provided to said cookware during the cooking, controlling the induction coil in order to regulate the increase of heating power provided to said cookware from a low heating power level to said high power level, the method further comprises the step of receiving a silent mode command which is indicative of a request for reducing the acoustic noise generated by said cookware when heated by said induction hob, measuring the temperature of the induction coil, measuring a time elapsed from receiving said high power user-command, delaying the increase of the heating power from the low heating power level to said high heating power level until a first condition or a second conditions are satisfied.

Preferably he first condition is satisfied when the induction coil temperature is greater than a prefixed temperature threshold.

Preferably, the second condition is satisfied when a prefixed-time-out corresponding to a prefixed time threshold is elapsed.

Preferably the method further comprises the steps of: measuring the noise/vibrations of said cookware, generating said silent mode command based on said measured noise/vibrations.

Preferably, the method further comprises the steps of receiving said silent mode command by said user via an interface of said induction hob.

The present invention further concerns a induction hob comprising: at least an induction coil for f heating a cookware, a user interface and an electronic control system which is configured in order to: receive via the user interface, a high power user-command which is indicative of a high power level to be provided to said cookware during the cooking, control the induction coil in order to regulate the increase of heating power provided to said cookware from a low heating power level to said high power level, the electronic control system is further configured in order to receive a silent mode command which is indicative of a request for reducing the acoustic noise generated by said cookware when heated by said induction hob, measure the temperature of the induction coil, measure a time elapsed from receiving said high power user-command, delays the increase of the heating power from the low heating power level to said high heating power level until a first condition or a second conditions are satisfied.

Preferably, electronic control system determines that the first condition is satisfied, when the induction coil temperature is greater than £ prefixed temperature threshold.

Preferably, electronic control system determines that the second condition is satisfied, when the measured time is greater than a prefixed time threshold.

Preferably, the electronic control system is further configured to measure the noise/vibrations of said cookware and automatically generates said silent mode command based on said measured noise/vibrations.

Preferably, the electronic control system is further configured of receive said silent mode command by said user via said user interface of said induction hob.

The claims describe preferred embodiments of the present invention forming an integral part of the present specification.

If not explicitly indicated otherwise, embodiments of the invention can be freely combined with each other.

### BRIEF DESCRIPTION OF THE DRAWINGS

The various aspects of the invention, including its particular features and advantages, will be readily understood from the following detailed description and the accompanying drawings, in which:

FIG. 1 schematically illustrates an induction hob made according to the teaching of the present invention,

FIG. 2 is a flow chart of the operation of the induction hob when it implements the method provided according to the present invention.

### PREFERRED EMBODIMENTS OF THE INVENTION

The present invention will now be described more fully with reference to the accompanying drawings, in which example embodiments are shown. However, this invention should not be construed as limited to the embodiments set forth herein. Throughout the following description similar reference numerals have been used to denote similar elements, parts, items or features, when applicable.

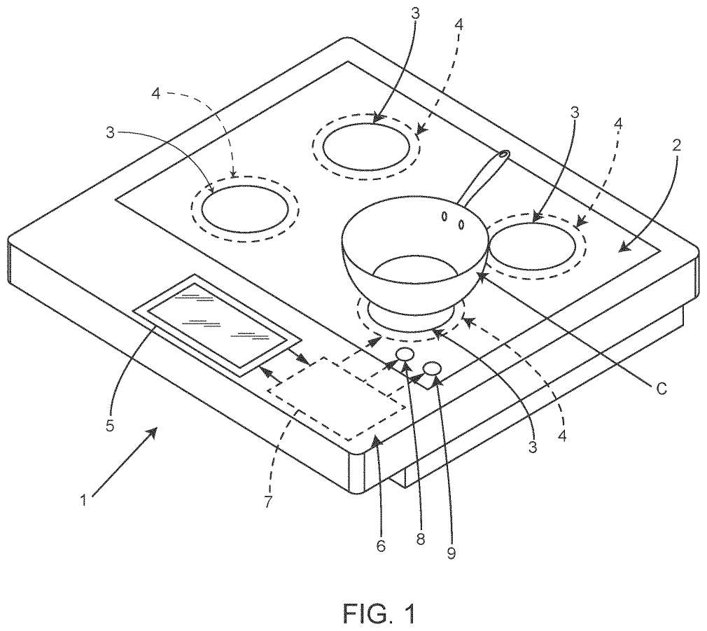

With reference to FIG. 1, number 1 indicates, as a whole, an induction hob made according to the present invention. The induction hob 1 may comprise a hob plate 2 and one or more heating zones 4 (shown by broken lines), which are arranged on the hob plate 2 and are structured in order to support respective cookwares C (one of them schematically illustrated in FIG. 1).

With reference to the exemplary embodiment shown in FIG. 1, each heating zone 4 is associated with at least an induction coil 3 configured to heat the cookware C. Preferably, the induction coil 3 may be arranged under the hob plate 2.

In the example shown in FIG. 1, the induction hob 1 further comprises a user-interface 5 for example comprised in a control panel of the induction hob 1.

The user-interface 5 may be configured in order to allow users to input/set commands to the induction hob 1 to perform the cooking (cycle).

According to an embodiment of the present invention illustrated in FIG. 1, the user-interface 5 may be further configured to allow the user to input/set command to select a heating power for cooking, among a plurality of prefixed heating powers.

According to the present invention the prefixed heating powers may comprise a number of prefixed heating powers hereinafter indicated as “high heating power levels”.

According to the present invention, the user interface 5 may be preferably configured in order to allow the user to input/set command of a “booster power level”, being indicative of the highest heating power level. For example, high heating power levels may have values comprised in a range around about 2000 W, whereas the boost power level may be a value of about 3000 W

According to an embodiment of the present invention illustrated in FIG. 1, the user-interface 5 may be further configured to allow the user to input/set command for selecting a “silent mode”.

The silent mode function, when is selected by user, causes the induction hob 1 to operate for reducing the acoustic noise generated by the cookware C during cooking.

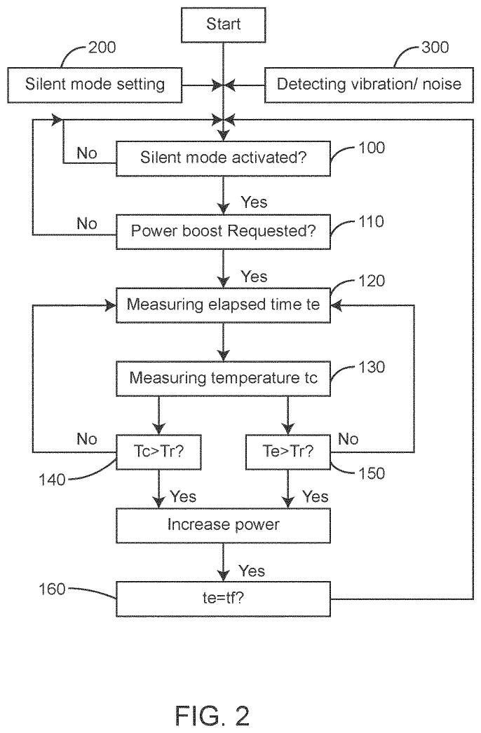

When the user inputs/sets the silent mode function, the induction hob 1 works in order to perform the steps of the operation method hereinafter disclosed in detail and illustrated by the flow chart of FIG. 2.

With reference to the example shown in FIG. 1, the induction hob 1 preferably comprise an electronic control system 6, which is configured to control the operation of the induction hob 1.

Preferably, the electronic control system 6 may comprise an electronic control unit 7.

Preferably, the electronic control system 6 may also comprise a temperature sensor 8. In the exemplary embodiment of FIG. 2, the temperature sensor 8 is configured to measure the temperature Tc of the induction coil 3.

It is understood that the present invention is not limited to a temperature sensor 8 configured to measure the temperature of the induction coil 3 but, alternately or in addition, the temperature sensor 8 may be arranged and configured in order to measure the temperature of the heating zone 4.

The electronic control unit 7 may be configured to control the electric power supplied to the induction coil 3 in order to regulate the heating power that induction coil 3 provides to the cookware C while cooking.

According to the present invention, when the user selects an high heating power level by the user interface 5, the electronic control 7 regulates the electric power supplied to the induction coil 3 so that the heating power increases from a prefixed low heating power, hereinafter indicated as initial low heating power level to the high heating power level selected by the user.

The heating power increase from the initial low heating power level to the high heating power level, for example the booster level, may be implemented by step/s and/or in a smooth and progressive way.

For example during the implementation of steps, induction hob 1 may keep the prefixed initial level lower than high heating level set by customer for a certain period.

The transition from the prefixed initial power level to the high heating power level may be carried-out for example in one step as soon as either a coil temperature threshold or a time threshold has been reached.

According to an exemplary embodiment of the present invention, for the implementation of a smooth and progressive increase of power, induction hob 1 starts cooking process with a initial prefixed low heating power, lower than setting by user. i.e. the high heating power level. Then, the power is increased gradually according to a certain slope to reach final power corresponding to the high heating level.

In case a temperature threshold has been reached, it is possible to accelerate the process or get final power in at least a step.

The slope of the heating power may be customized by user and, eventually, adapted to cookware C used by user.

During a cooking cycle, the electronic control unit 7 controls the electric power supplied to the induction coil 3 in order to regulate the heating power which the latter provides to the cookware C in order to increase the heating power from the prefixed low heating power level to the high heating power level.

According to the present invention, the electronic control unit 7 is configured in order to receive in input the silent mode command which is indicative of the user's request for reducing the acoustic noise generated by the cookware C when the latter is heated by the induction hob 1, and delays the transition from the initial low heating power level to the high power level until a first or a second conditions are satisfied.

According to the present invention the first condition is satisfied when the induction coil temperature is above a prefixed temperature threshold. The second condition is satisfied when a prefixed-time-out corresponding to the time threshold elapsed.

The applicant has found that acoustic noise tends to peak when cookware C is cold and then it reduces with the heat-up. At the beginning of cooking, there is a temperature difference between the outer layer that is heated immediately by induction and the inner layers that are heated by thermal conduction. Therefore, intensity of the noise depends on the heating power provided to the cookware C.

The technical effect obtained by delaying the instant in which the heating power passes from low heating power level to the high heating power level is to reduce the acoustic noise generated by the cookware C.

With reference to the flow chart illustrated in FIG. 2, the method to operate the induction hob 1 comprises the following steps.

The method comprises the step of controlling whether the silent mode command has been selected (block 100).

It is understood that the silent mode function may be activated based on the user-command given through the user interface 5 (block 200) and/or automatically by the sensor device 9 based on noise/vibrations (block 300).

If the silent mode is activated (output YES block 100), the method may check whether a command concerning a high power level, i.e. a boost level, has been selected (block 110), and if so (output YES block 110), it measures the elapsed-time te (block 120).

Moreover, the method performs the step of measuring the temperature Tc of the induction coil 11 (block 130).

Next, the method controls whether the first condition or the second condition are satisfied.

The method checks the first condition, i.e. if the elapsed-time te is greater than the prefixed time threshold tr (te>tr) (block 150).

Moreover the method checks the second condition, i.e. whether the measured temperature Tc is greater than the temperature threshold Tr (Tc>Tr) (block 140).

If the measured time te is greater than a prefixed time threshold tr (output Yes block 150), or the measured coil temperature Tc is greater than the temperature threshold Tr (output YES block 140), the method controls the electric power supplied to the induction coil 3 in order to increase the heating power provided to the cookware C from the initial low heating power level to the high heating power level that in the example corresponds to the booster power level.

In other words, when the first and second conditions are satisfied, the heating power provided to the cookware passes from the initial low heating power level to the high heating power level, which in the example corresponds to the booster power level.

The method ends when the measured time te reaches a prefixed end time tf.

The present invention have the advantage of reducing the acoustic noise generated by the cookware, by implementing a method, which is simpler and cheaper to be performed than the known solutions.

Clearly, changes and variations may be made to the induction hob and to the method, departing from the scope of the present invention.

1. A method of operating an induction hob comprising at least one induction coil for heating a cookware, the method comprising the steps of:
receiving a high-power command that is indicative of a high-power level to be provided to said cookware during cooking,
controlling the induction coil in order to increase heating power provided to said cookware from a low-power level to said high-power level,
receiving a silent-mode command that is indicative of a request for reducing acoustic noise generated by said cookware when heated by said induction coil,
measuring a temperature of the induction coil, and
measuring a time elapsed from receiving said high-power command,
wherein the increase of the heating power from the low-power level to said high-power level is delayed until a first condition or a second condition is satisfied.

2. The method according to claim 1, wherein:
the first condition comprises the measured temperature of the induction coil being greater than a prefixed temperature threshold, and/or
the second condition comprises the measured time reaching a prefixed time threshold.

3. The method according to claim 1, wherein:
the first condition comprises the measured temperature of the induction coil being greater than a prefixed temperature threshold, and
the second condition comprises the measured time reaching a prefixed time threshold.

4. The method according to claim 1, wherein the method comprises:
measuring noise/vibrations of said cookware,
generating said silent-mode command based on said measured noise/vibrations.

5. The method according to claim 1, wherein the silent-mode command is received by a user interface.

6. An induction hob comprising:
at least one induction coil for heating a cookware,
a user interface, and
an electronic control system that is configured to:
receive a high-power command that is indicative of a high-power level to be provided to said cookware (C) during cooking,
control the induction coil in order to increase heating power provided to said cookware from a low-power level to said high-power level,
receive a silent-mode command that is indicative of a request for reducing acoustic noise generated by said cookware during when heated by said induction coil,
measure a temperature of the induction coil, and
measure a time elapsed from receiving said high-power command,
wherein the electronic control system is configured to delay the increase of the heating power from the low-power level to said high-power level until a first condition or a second conditions is satisfied.

7. The induction hob according to claim 6, wherein:
said first condition comprises the temperature of the induction coil being greater than a prefixed temperature threshold, and/or
said second condition comprises the measured time reaching a prefixed time threshold.

8. The induction hob according to claim 6, wherein:
said first condition comprises the temperature of the induction coil being greater than a prefixed temperature threshold, and
said second condition comprises the measured time reaching a prefixed time threshold.

9. The induction hob according to claim 6, wherein the electronic control system is configured to:
measure noise/vibrations of said cookware,
generate said silent-mode command based on said measured noise/vibrations.

10. The induction hob according to claim 6, further comprising a user interface configured to receive said silent-mode command.

11. A method of operating the induction hob according to claim 6, wherein the electronic control system:
receives the high-power command and silent-mode command,
measures the temperature of the induction coil and the time elapsed from receiving said high-power command, and
controls the induction coil in order to increase the heating power provided to said cookware from the low-power level to said high-power level,
wherein the electronic control system delays the increase of the heating power from the low-power level to said high-power level until the first condition or the second conditions is satisfied.

12. The method according to claim 11, wherein:
the first condition comprises the measured temperature of the induction coil being greater than a prefixed temperature threshold, and/or
the second condition comprises the measured time reaching a prefixed time threshold.

13. The method according to claim 11, wherein:
the first condition comprises the measured temperature of the induction coil being greater than a prefixed temperature threshold, and the second condition comprises the measured time reaching a prefixed time threshold.

14. The method according to claim 11, wherein the silent-mode command is received by a user interface of the electronic control system.

15. The method according to claim 11, wherein the electronic control system:
measures noise/vibrations of said cookware, and
generates said silent-mode command based on said measured noise/vibrations.

16. A method of operating an induction hob comprising an induction coil for heating a cookware, the method comprising the steps of:
receiving a high-power command that is indicative of a high-power level to be provided to said cookware during cooking,
receiving a silent-mode command that is indicative of a request for reducing acoustic noise generated by said cookware when heated by said induction coil, and
controlling the induction coil in order to increase heating power provided to said cookware from a low-power level to said high-power level,
wherein the step of controlling the induction coil to increase heating power provided to said cookware is delayed until a first condition or a second condition is satisfied.

17. The method according to claim 16, wherein:
the first condition comprises a temperature of the induction coil being greater than a prefixed temperature threshold, and/or
the second condition comprises a time elapsed from receiving said high-power command reaching a prefixed time threshold.

18. The method according to claim 16, wherein:
the first condition comprises a temperature of the induction coil being greater than a prefixed temperature threshold, and
the second condition comprises a time elapsed from receiving said high-power command reaching a prefixed time threshold.

19. The method according to claim 16, wherein the method comprises:
measuring noise/vibrations of said cookware,
generating said silent-mode command based on said measured noise/vibrations.

20. The method according to claim 16, wherein the silent-mode command is received by a user interface of the induction hob.
